(19) United States
(12) Patent Application Publication
(10) Pub. No.: US 2023/0188659 A1
(43) Pub. Date: Jun. 15, 2023

(54) IMAGE FORMING APPARATUS AND METHOD

(71) Applicant: CANON KABUSHIKI KAISHA, Tokyo (JP)

(72) Inventors: Katsutoshi Miyahara, Kanagawa (JP); Tomoya Teraji, Tokyo (JP); Takehiko Kasamatsu, Kanagawa (JP); Shota Nonaka, Kanagawa (JP)

(21) Appl. No.: 17/986,809

(22) Filed: Nov. 14, 2022

(30) Foreign Application Priority Data
Dec. 9, 2021 (JP) 2021-200393

(51) Int. Cl. H04N 1/12; H04N 1/191; H04N 1/00

(52) U.S. Cl. CPC H04N 1/1215; H04N 1/1911; H04N 1/00952

(57) ABSTRACT

In filter processing, a filter coefficient for which a weighting has been set is used for each of a plurality of pixels in a sub-scanning direction in a predetermined section of a main-scanning direction and the weighting for each of the plurality of pixels is determined such that a center of gravity of the weighting shifts in the main-scanning direction gradually from one end of the predetermined section to the other end.

### BACKGROUND OF THE INVENTION

### Field of the Invention

The present invention relates to an image forming apparatus and a method for reading an original image by an image sensor unit.

### Description of the Related Art

In a wide-width image reading apparatus, instead of using a long image sensor, to reduce the cost of the main body, a configuration is generally taken in which a plurality of image sensors of an A4 size or an A3 size are arranged to achieve a desired reading width. In such a configuration, it is necessary to form one image by joining the read images of the respective image sensors.

In the formation of the image, an effect of inclination of images read by each image sensor caused by manufacturing tolerances of the apparatus or the like is corrected and then the read images are joined. As a method for correcting the inclination of the read images, Japanese Patent Laid-Open No. 2017-147592 describes a correction method in which a unit for shifting image data in a predetermined direction is obtained from the inclination of an original and the image data is shifted in the main-scanning direction or the sub-scanning direction for each predetermined number of lines. Further, in order to maintain continuity of the image data, an interpolation method is described in which a gradation value of a target pixel and a gradation value of an adjacent pixel are weighted and summed.

### SUMMARY OF THE INVENTION

The present invention provides an image forming apparatus and method for suppressing an increase in circuit scale and a decrease in processing speed that occur when setting a weight to filter coefficients in filter processing for read data.

The present invention in one aspect provides an image forming apparatus, comprising: a reading unit configured to include an image sensor unit in which a reading element for optically reading an original in a main-scanning direction is arranged; a conversion unit configured to, by performing filter processing of a spatial frequency on read data read by the image sensor unit for each predetermined section of the main-scanning direction, perform gradation conversion of a sub-scanning direction intersecting the main-scanning direction in each predetermined section; and a correction unit configured to correct read data obtained in accompaniment of an inclination of the image sensor unit by shifting pixels in the sub-scanning direction for data on which the gradation conversion has been performed by the conversion unit, wherein in the filter processing, a filter coefficient for which a weighting has been set is used for each of a plurality of pixels in the sub-scanning direction in the predetermined sections, and the weighting for each of the plurality of pixels is determined such that the center of gravity of the weighting shifts in the main-scanning direction gradually from one end of the predetermined section to the other end.

By virtue of the present invention, it is possible to suppress an increase in circuit scale and a decrease in processing speed that occur in a case of setting a weighting to filter coefficients in filter processing for read data.

Further features of the present invention will become apparent from the following description of exemplary embodiments with reference to the attached drawings.

### BRIEF DESCRIPTION OF THE DRAWINGS

FIGS. 1A and 1B are views illustrating an external perspective of a scanner unit.

FIG. 2 is a view illustrating a block configuration of an MFP.

FIG. 3 is a view illustrating a configuration of a read image combination unit.

FIG. 4 is a view illustrating a configuration of a filter processing unit.

FIG. 5 is a view illustrating block data of m×n pixels.

FIGS. 6A to 6C are views for describing that filter coefficients follow a normal distribution curve.

FIG. 7 is a view illustrating filter coefficients corresponding to addresses in the main-scanning direction.

FIGS. 8A to 8D are views illustrating an effect of the present embodiment.

FIG. 9 is a flowchart illustrating correction processing.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate.

Furthermore, in the attached drawings, the same reference numerals are given to the same or similar configurations, and redundant description thereof is omitted.

In the configuration of Japanese Patent Laid-Open No. 2017-147592, it is necessary to separately provide a processing unit that performs weighting processing, and there is concern about an increase in circuit scale and the accompanied decrease in processing speed.

By virtue of the present disclosure, it is possible to suppress an increase in circuit scale and a decrease in processing speed that occur in a case of setting a weighting to filter coefficients in filter processing for read data.

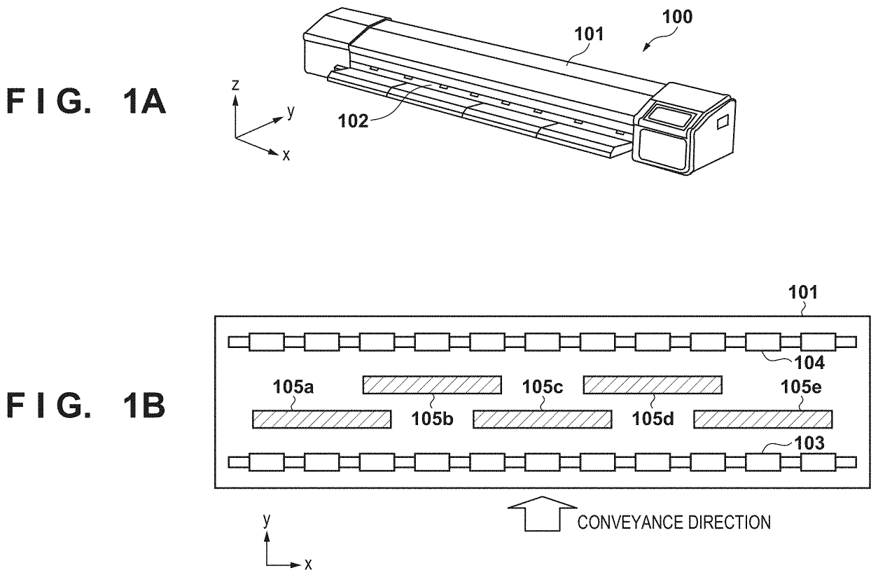

FIG. 1A shows an external perspective view of a scanner unit 101 of a multifunction peripheral (MFP: Multifunctional Peripheral) 100 according to the present embodiment. Also, FIG. 1B shows a top view of the inside of the scanner unit 101. In the present embodiment, the MFP 100 is described as an image forming apparatus in which a reading function and a printing function are integrally configured, but other functions such as a facsimile function and a transmission function, for example, may be configured. The scanner unit 101 is a sheet feed type reading apparatus, and optically reads an original image while causing the original fed from an original sheet feed port 102 to be conveyed. Inside the scanner unit 101, an upstream conveyance roller 103 and a downstream conveyance roller 104 are arranged, and five image sensor units 105a, 105b, 105c, 105d, and 105e are arranged in a staggered manner in the main-scanning direction therebetween. In the present embodiment, reading elements are arranged in the main-scanning direction for each of the image sensor units 105a to 105e, and have, for example, A4 size read widths. In the MFP 100, a 36-inch-wide read image can be obtained by joining read images obtained by each of the image sensor units 105a to 105e. Note, in FIG. 1B, the x-direction indicates the main-scanning direction, and the y-direction indicates the sub-scanning direction which intersects the main-scanning direction.

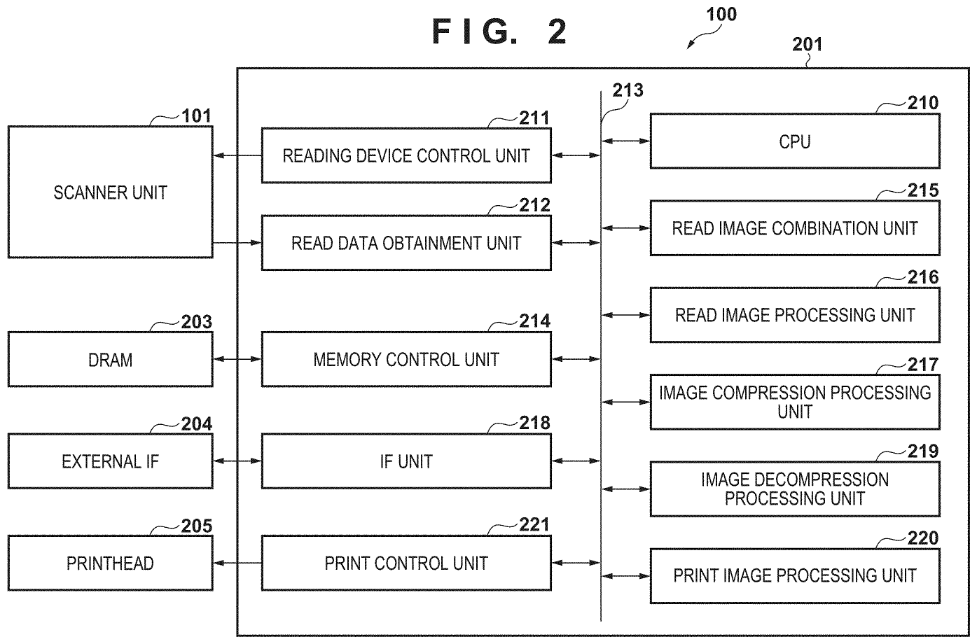

FIG. 2 is a block diagram for describing an electric schematic configuration of the MFP 100. FIG. 2 is a block diagram focusing on the reading function and the printing function of the MFP 100, and may appropriately include a block configuration corresponding to a function that can be realized by the MFP 100. An ASIC 201 performs control of the image sensor units 105a to 105e in the scanner unit 101, obtainment of read data inputted from the image sensor units 105a to 105e, image processing, printing control, and the like. Note that ASIC is an abbreviation for Application Specific Integrated Circuit. The internal configuration of the ASIC 201 is described later.

A DRAM 203 is used as a buffer memory for temporarily storing read data read by the image sensor units 105a to 105e and image data for printing. An external interface (IF) 204 is an interface for communication with an external apparatus, and is configured as, for example, a USB interface or a LAN interface. The external interface 204 is used, for example, for a purpose such as outputting read data to the external apparatus. A printhead 205 prints an image by ejecting ink droplets onto a printing medium by an ink-jet printing method.

The ASIC 201 is configured to include each of the following processing units. A CPU 210 comprehensively controls each processing unit. A reading device control unit 211 is connected to the image sensor units 105a to 105e, and performs reading control by, for example, generating a timing signal for the image sensor units 105a to 105e and a control signal for an RGB light source.

A read data obtainment unit 212 is connected to the image sensor units 105a to 105e, performs processing for converting data outputted from the image sensor units 105a to 105e into pixel data and processing for rearranging the pixel data according to the arrangement of pixels. The read data obtainment unit 212 also performs pre-processing before processing by a subsequent processing unit. For example, the read data obtainment unit 212 performs shading processing for causing optical variation and sensitivity variation of the sensor to be reduced, and gamma lookup table correction processing for correcting linearity of the output.

The read data obtainment unit 212 includes, for example, five processing circuits to individually perform processing on the read data obtained from each of the five image sensor units 105a to 105e. Also, the read data obtainment unit 212 is connected to an internal bus 213 in the ASIC 201. The internal bus 213 is connected to a memory control unit 214 which is an interface of the DRAM 203 which is an external memory. Note, although not shown, the read data obtainment unit 212 has a built-in DMAC (Direct Memory Access). Therefore, the read data obtainment unit 212 can write the read data, that has been obtained from the image sensor units 105a to 105e and processed, to the read image buffer region of the DRAM 203 via the internal bus 213 and the memory control unit 214.

A read image combination unit 215 is a processing unit for performing combination processing on read data corresponding to each of the image sensor units 105a to 105e. The read image combination unit 215 includes a processing unit for correcting, in advance, variations in attachment and variations in color sensitivity of each of the image sensor units 105a to 105e in executing the combination processing and a processing unit for reducing the resolution, and the like. A detailed internal configuration of the read image combination unit 215 is described later. The read image combination unit 215 is connected to the internal bus 213. Note, although not shown, the read image combination unit 215 has a DMAC built in. Therefore, the read image combination unit 215 can read the read data from the read image buffer region of the DRAM 203 via the internal bus 213 and the memory control unit 214, and write the processed image data into a combined image buffer region of the DRAM 203.

A read image processing unit 216 is a processing unit for processing and correcting the image data on which combination processing has been performed by the read image combination unit 215 according to the usage, and executes, for example, edge emphasis processing, rotation processing, magnification processing, and the like of the image data. The read image processing unit 216 is connected to the internal bus 213. Note, although not shown, the read image processing unit 216 has a DMAC built in. Therefore, the read image processing unit 216 can read the image data from the combined image buffer region of the DRAM 203 via the internal bus 213 and the memory control unit 214, and write the processed image data into a processed image buffer region of the DRAM 203.

An image compression processing unit 217 is a processing unit that executes compression processing for compressing image data. The image compression processing unit 217 is connected to the internal bus 213. Note, although not shown, the image compression processing unit 217 has a DMAC built in. Therefore, the image compression processing unit 217 can read the image data from the processed image buffer region of the DRAM 203 via the internal bus 213 and the memory control unit 214 and execute compression processing, and write the processed image data into a compressed image buffer region of the DRAM 203. Note, in a case where the read image data is outputted to an external apparatus, the image data written in the compressed image buffer region of the DRAM 203 is outputted via the external IF unit 204.

An image decompression processing unit 219 is a processing unit that executes decompression processing for decompressing compressed image data. The image decompression processing unit 219 is connected to the internal bus 213. Note, although not shown, the image decompression processing unit 219 has a DMAC built in. Therefore, the image decompression processing unit 219 can read the image data written to the compressed image buffer region of the DRAM 203 via the internal bus 213 and the memory control unit 214 and execute decompression processing, and write the processed image data into a decompressed image buffer region of the DRAM 203.

A print image processing unit 220 is a processing unit for converting image data into print data according to print settings. The print image processing unit 220 is connected to the internal bus 213. Note, although not shown, the print image processing unit 220 has a DMAC built in. The print image processing unit 220 can read the image data in the processed image buffer region or the decompressed image buffer region of the DRAM 203 via the internal bus 213 and the memory control unit 214 to execute the processing, and can write the processed image data into the print data buffer region of the DRAM 203.

A print control unit 221 is a processing unit for converting the image data converted into the print data into a drive signal for driving a printing element of the printhead 205. The print control unit 221 is connected to the internal bus 213. Note, although not shown, the print control unit 221 has a DMAC built in. Therefore, the print control unit 221 can read the data in the print data buffer region of the DRAM 203 via the internal bus 213 and the memory control unit 214, convert the data into a drive signal for the printhead 205, and output the drive signal to the printhead 205.

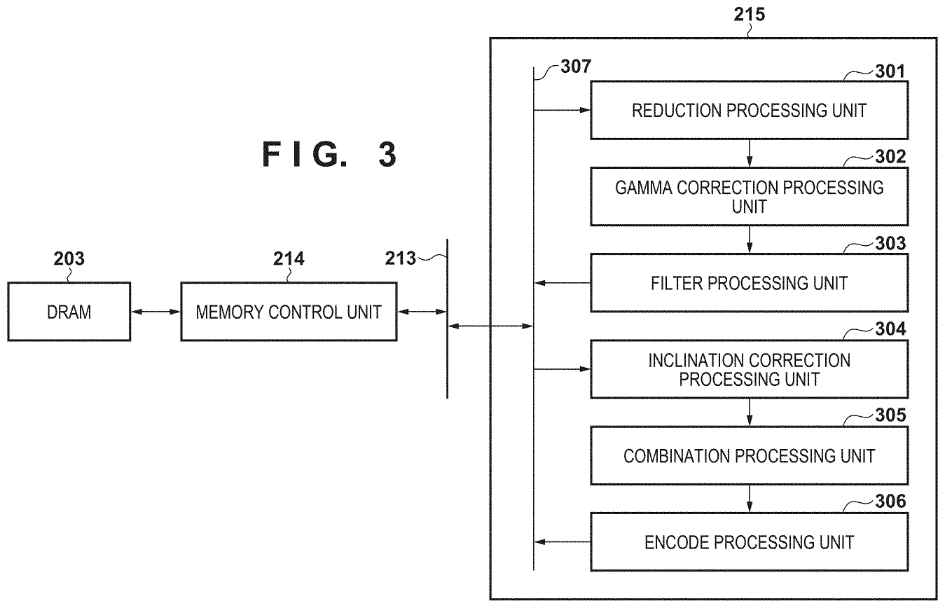

Next, the internal configuration of the read image combination unit 215 is described. FIG. 3 is a block diagram showing an internal configuration of the read image combination unit 215. The read image combination unit 215 includes a reduction processing unit 301, a gamma conversion processing unit 302, a filter processing unit 303, an inclination correction processing unit 304, a combination processing unit 305, and an encode processing unit 306. An internal bus 307 is configured so as to connect these processing units with the internal bus 213.

The reduction processing unit 301 is a processing unit that executes processing for reducing the read image so as to have an optimum resolution for subsequent image processing. The reduction processing unit 301 is connected to the internal bus 307. The reduction processing unit 301 reads the read data in units of blocks from the read image buffer region of the DRAM 203 via the internal buses 307 and 213 and the memory control unit 214 by the DMAC built into the reduction processing unit 301, and outputs the reduced image data (pixel data). The gamma correction processing unit 302 is a processing unit that executes three dimensional gamma correction processing on the pixel data outputted from the reduction processing unit 301.

The filter processing unit 303 is a processing unit for performing a filter calculation for reducing noise included in the read data and changing the spatial frequency, and weighting by filter coefficients for correcting the inclination of the image sensor units 105a to 105e with high accuracy. The filter processing unit 303 executes filter processing on the pixel data outputted from the gamma correction processing unit 302. The filter processing unit 303 is connected to the internal bus 307, and writes the processed image data into a filtered image buffer region of the DRAM 203 via the internal buses 307 and 213 and the memory control unit 214 by the built-in DMAC. The internal configuration of the filter processing unit 303 is described later.

The inclination correction processing unit 304 is a processing unit that executes correction processing for correcting an inclination of the image data. The inclination correction processing unit 304 is connected to the internal bus 307, and reads the filter processed image data of the filtered image buffer region of the DRAM 203 via the internal buses 307 and 213 and the memory control unit 214 by the built-in DMAC.

The inclination correction processing unit 304 reads the image data in units of one line by the internal DMAC, and has a function of shifting the coordinates in the sub-scanning direction during reading in accordance with the inclination information of the image sensor units 105a to 105e. For example, it is assumed that the read image obtained from the image sensor unit 105a has an inclination such that the read image is shifted by one pixel in the sub-scanning direction for every x pixels in the main-scanning direction. In this case, the internal DMAC causes the sub-scanning position at which the next pixel starts to be read to shift by one pixel for every x pixels read, and continuously performs reading. When the reading of the line data of one image sensor unit, for example, the image sensor unit 105a, is completed, the reading of the line data of the adjacent image sensor unit, for example, the image sensor unit 105b is successively performed. At this time, the offset of the line position is set so that the line data at the same sub-scanning position of the original to be read is read.

The combination processing unit 305 is a processing unit that performs combination processing of line data of different image sensor units according to the positional relationship of the respective image sensor units. The combination processing unit 305 is connected to the inclination correction processing unit 304, and the line data corresponding to the image sensor units 105a to 105e is sequentially inputted from the inclination correction processing unit 304. The combination processing unit 305 determines a combination processing section of adjacent image sensor units based on correction information obtained in advance. The combination processing section corresponds to, for example, an overlapping section in the sub-scanning direction of the image sensor units 105a and 105b of FIG. 1B. Before the combination processing section, the pixel data of the image sensor units on the side to be combined are outputted as valid pixels. Also, after the combination processing section, the pixel data of the image sensor units on the side combined are outputted as valid pixels. In the combination processing section, calculation processing based on mask data for error reduction is performed on the pixel data of the side to be combined and side combined respectively, and the data is outputted. Similar processing is performed for all the combination processing sections, and as a result, line data of one line, which is the line data of each of the image sensor units 105a to 105e combined, is outputted from the combination processing unit 305.

The encode processing unit 306 is a processing unit that executes compression processing by differential pulse code modulation (DPCM) on the inputted line data. The encode processing unit 306 is connected to the combination processing unit 305 and the internal bus 307. The encode processing unit 306 performs encode processing on the line data inputted from the combination processing unit 305, and writes the processed data into the combined image buffer region of the DRAM via the internal buses 307 and 213 and the memory control unit 214 by the built-in DMAC.

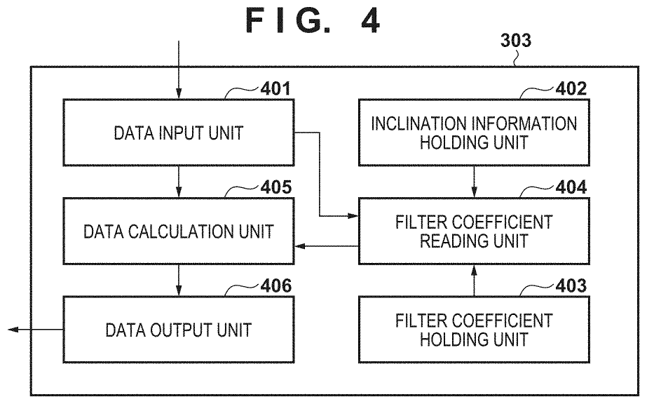

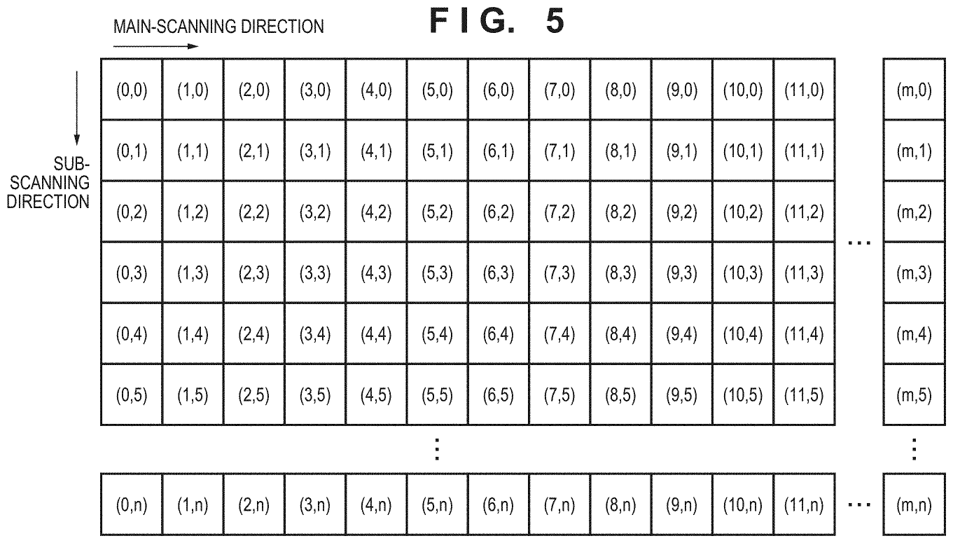

Next, a circuit configuration of the inside of the filter processing unit 303 is described. FIG. 4 is a block diagram showing an internal configuration of the filter processing unit 303. Further, FIG. 5 describes block data of m×n pixels inputted from the gamma correction processing unit 302. Here, m represents the number of pixels in the main-scanning direction, and n represents the number of pixels in the sub-scanning direction. The numbers written in each of the squares in the figure represent the coordinates within the blocks, and it is assumed that Di[x,y] represents the data of the respective coordinates. Here, for the sake of simplicity of description, block data in which main-scanning coordinates are started from 0 are used, but the block data following the block data shown in FIG. 5 are data of coordinates [m+1, 0] to [2×m,n]. In the filter processing unit 303, convolution calculation processing is performed by using filter coefficients for data of five consecutive pixels in the sub-scanning direction from the inputted block data. In the present embodiment, data of five pixels is described as an example, but configuration may be taken such that the number of pixels is not five pixels.

The data input unit 401 is a processing unit for receiving the pixel data outputted from the gamma correction processing unit 302, and rearranging and outputting the arrangement of the data according to the calculation content of a calculation unit in the subsequent stage. From the gamma correction processing unit 302, RGB data is inputted in parallel in units of one pixel as block data. The data input unit 401 has an internal buffer, and is configured so as to write input data continuous in the main-scanning direction into the buffer once. In a case where the data of five consecutive pixels in the sub-scanning direction have been aligned according to the pixel data already stored in the buffer and the newly inputted pixel data, the data of five pixels (for example, Di[0,0] to Di[0,4]) are collectively outputted to the subsequent processing unit.

An inclination information holding unit 402 is a register unit that holds parameters related to the mounting inclination of the image sensor units 105a to 105e. The inclination information holding unit 402 is connected to the CPU 210 via a bus bridge circuit unit (not shown), and a register value can be rewritten from the CPU 210. The register value is rewritten to a set value corresponding to the reading resolution immediately before the reading operation. Inclination information held by the inclination information holding unit 402 includes, for example, an initial address for reading filter coefficients from a filter coefficient holding unit 403, an address switching threshold, and an address initialization threshold. These values are described later. The address switching threshold and the address initialization threshold are values determined for each image sensor unit, and the smaller the value, the shorter the switching interval of the filter coefficients, that is, the steeper the correction angle of the image sensor unit. Since these thresholds are determined when the image sensor units 105a to 105e are attached to the main body of the scanner unit 101, configuration may be taken such that the thresholds are measured in advance, for example, at the time of shipping from the factory and the like to determine the setting values, and then are stored in the storage unit within the MFP 100.

In the present embodiment, as an example, processing in a case where the initial address set for the image sensor unit 105a is “0”, the address switching threshold is “1”, and the address initialization threshold is “11” is described. These are the setting values in a case of correcting data in which a line image in the main-scanning direction read by the image sensor unit 105a is read as read data inclined by one pixel in the sub-scanning direction per predetermined section (11 pixels) of the main-scanning direction. The present setting values are numerical values for simplifying the description and are not limited to those values, and for example, a larger value may be set.

The filter coefficient holding unit 403 is a processing unit that stores filter coefficients, and is configured by, for example, an SRAM. The filter coefficient holding unit 403 holds, for example, filter coefficients k[0] to k[4] used in one calculation within one word of data. The filter coefficients are used to change a spatial frequency for a plurality of pixel data that are consecutive in the sub-scanning direction, and to perform weighting on pixel positions.

Hereinafter, a method of deriving the filter coefficients held by the filter coefficient holding unit 403 is described. A change of the spatial frequency is executed for the purpose of reducing noise, unevenness, and the like by cutting a high-frequency component of an image. In the present embodiment, description is given assuming that a unique normal distribution curve is given for each image sensor unit.

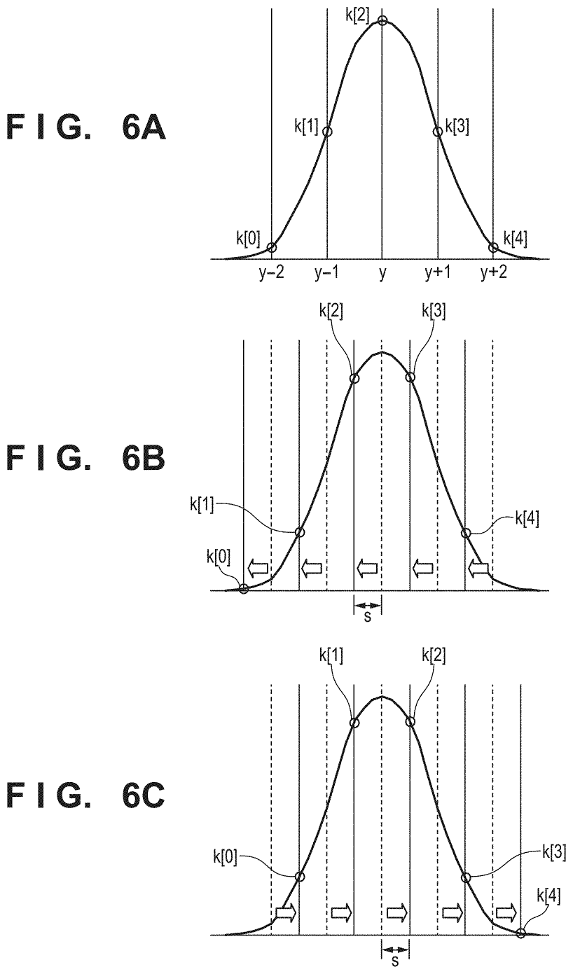

FIGS. 6A to 6C are representations of a normal distribution curve H given to the image sensor unit 105a and calculation positions of the filter coefficients k, as one example. FIG. 6A shows a position at which coefficients to be applied to the sixth pixels, which are the center coordinates of 11 pixels in the main-scanning direction, are obtained, and each coefficient k is obtained as follows.

k[0]=H[y−2]

k[1]=H[y−1]

k[2]=H[y]

k[3]=H[y+1]

k[4]=H[y+2]

In other words, the values converted for calculation from the above-described k[0], k[1], k[2], k[3], and k[4] are applied to the sixth pixels respectively at the center of the 11 pixels in the main-scanning direction of pixels 0 to 10 in FIG. 5, that is, Di[5,0], Di[5,1], Di[5,2], Di[5,3], and Di[5,4].

On the other hand, the filter coefficients k for moving a pixel by s pixels in the sub-scanning direction according to weighting correspond to the position moved by s from each of the coefficient calculation positions described above. Here, s is a numerical value less than an absolute value of 1, indicates a positive direction of sub-scanning when positive, and indicates a negative direction of sub-scanning when negative. That is, the filter coefficients k for shifting the image by s pixels in the sub-scanning direction are obtained as follows.

k[0]=H[y+s−2]

k[1]=H[y+s−1]

k[2]=H[y+s]

k[3]=H[y+s+1]

k[4]=H[y+s+2]

FIG. 6B is a view illustrating a case where s=−0.45 and showing the filter coefficients to be applied to the pixel data of the first pixels in the main-scanning direction. In other words, the values converted for calculation from k[0], k[1], k[2], k[3], and k[4] in a case where s=−0.45 by the equation described above are applied to the first pixels respectively of the 11 pixels in the main-scanning direction of pixels 0 to 10 in FIG. 5, that is, Di[0,0], Di[0,1], Di[0,2], Di[0,3], and Di[0,4].

FIG. 6C is a view illustrating a case where s=0.45 and shows the filter coefficients to be applied to the pixel data of the 11th pixels in the main-scanning direction. In other words, the values converted for calculation from k[0], k[1], k[2], k[3], and k[4] in a case where s=0.45 by the equation described above are applied to the 11th pixels respectively of the 11 pixels in the main-scanning direction of pixels 0 to 10 in FIG. 5, that is, Di[10,0], Di[10,1], Di[10,2], Di[10,3], and Di[10,4].

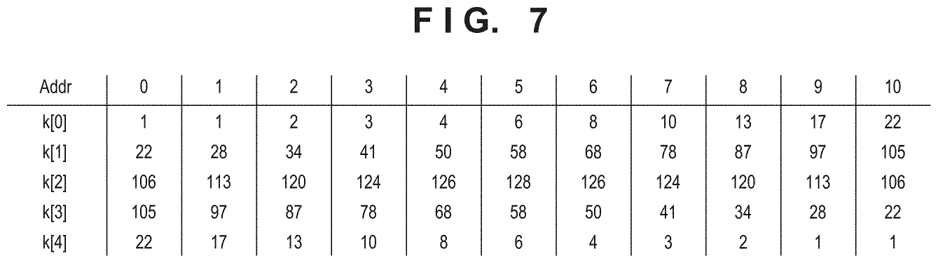

For the filter coefficients k obtained as described above for each pixel data in the main-scanning direction, values converted into a numerical value suitable for use in calculation (for example, values for which the coefficients sum to a power of 2) are written in the filter coefficient holding unit 403. The sum of the coefficients is constant in the main-scanning direction as shown in FIG. 7.

FIG. 7 is a view illustrating an example of filter coefficients written in the filter coefficient holding unit 403. Five filter coefficients k[0] to k[4] used in one calculation are stored in one address, and filter coefficients are stored in addresses of 11 words in total.

As shown in FIG. 7, in a unit block of 11 pixels in the main-scanning direction, that is, a unit block in the main-scanning direction that is read inclined by 1 pixel in the sub-scanning direction, the center of gravity of the weighting is biased to the side of k[4] for the first pixels in the main-scanning direction (column “0” in FIG. 7). Also, for the sixth pixels in the main-scanning direction (column “5” in FIG. 7), the center of gravity of the weighting is k[2]. Also, for the 11th pixels in the main-scanning direction (column “10” in FIG. 7), the center of gravity of the weighting is biased to the side of k[0].

As described above, in the filter processing unit 303 of the present embodiment, the filter coefficients are determined so that the center of gravity of the weighting of the filter coefficients gradually moves in the sub-scanning direction from the first pixels (one end) to the end pixels (the other end) in the unit block in the main-scanning direction that is read inclined by one pixel in the sub-scanning direction. In this case, the filtering strength of the filter coefficient is constant in the main-scanning direction. As a result, the data outputted from the filter processing unit 303 can be brought into a state in which the inclination is corrected in unit blocks of the main-scanning direction.

The size (number of words) of the SRAM of the filter coefficient holding unit 403 is correlated with the accuracy of correction of the inclination. For example, in a case of performing weighting by dividing the interval of one pixel in the sub-scanning direction into 16, an SRAM capacity of 16 words is required. Therefore, by increasing the size of the SRAM, the correction can be performed with a higher resolution.

A filter coefficient reading unit 404 is a processing unit that reads filter coefficients from the filter coefficient holding unit 403. The filter coefficient reading unit 404 includes an address calculation unit for calculating an address (Addr) in which filter coefficients to be read from the filter coefficient holding unit 403 are stored. The address calculation unit is configured to read the initial address register from the inclination information holding unit 402 and set it as the initial value of a read address when processing is performed on a block including the leading pixel of the line data.

Upon receiving a notification of an output of data from the data input unit 401, the filter coefficient reading unit 404 accesses the address (Addr) calculated by the address calculation unit in the filter coefficient holding unit 403, and reads the stored filter coefficients k[0] to k[4].

The filter coefficient reading unit 404 includes an address switching counter and an address initialization counter, and when a notification signal of data output is received from the data input unit 401, counts up each counter. The count value of the address switching counter is compared with the address switching threshold read from the inclination information holding unit 402, and when the count value becomes equal to or larger than a threshold, address switching (+1 increment) is performed. Here, the address switching means that the address to be read in the filter coefficient holding unit 403 is shifted by one in the main-scanning direction.

Also, the count value of the address initialization counter is compared with the address initialization threshold read from the inclination information holding unit 402, and when the count value becomes equal to or larger than a threshold, address initialization is performed. Here, address initialization means returning to reading the filter coefficients at the address of the first pixel of the unit block. Further, when the end pixel of the block in the main-scanning direction is reached, the address is switched to the address of the leading end of the block, and when the final calculation position of the block data is reached, the address is switched to the address for the leading end of the next block. In a case where neither of the above conditions are satisfied, the filter coefficient reading unit 404 reads the filter coefficients of the same address even when the next notification signal is received.

A data calculation unit 405 is a processing unit that performs calculation processing for filtering on pixel data inputted from the outside by the data input unit 401. Data Di[x,y−2] to Di[x,y+2] for five consecutive pixels in the sub-scanning direction are inputted from the data input unit 401. At the same time, the filter coefficients k[0] to k[4] are inputted from the filter coefficient reading unit 404. The data calculation unit 405 calculates the output pixel data Do[x,y] of the coordinate [x,y] by the following Equation (1) using the inputted data. That is, a convolution calculation using the filter coefficients k[0] to k[4] is performed.

Do[x,y]=(k[0]Di[x,y−2]+k[1]Di[x,y−1]+k[2]Di[x,y]+k[3]Di[x,y+1]+k[4]Di[x,y+2])/Sk (1)

Here, Sk=k[0]+k[1]+k[2]+k[3]+k[4]

The data output unit 406 writes the pixel data, on which calculation processing has been performed by the data calculation unit 405, to the DRAM 203 via the internal buses 307 and 213 and the memory control unit 214 by the built-in DMAC.

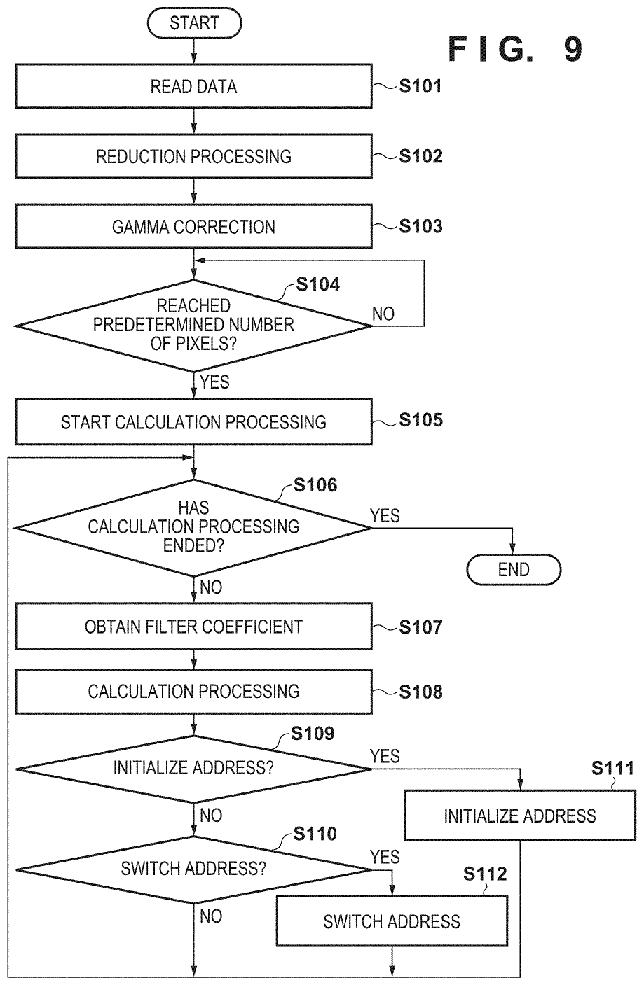

Next, processing for correcting the read images in the MFP 100 is described while referring to the flow chart of FIG. 9. The processing of FIG. 9 is executed by the read image combination unit 215. The data read by the five image sensor units 105a to 105e are obtained by the read data obtainment unit 212 of the ASIC 201 and written into a read data buffer region of the DRAM 203. When image data of a predetermined number of lines is written in the read data buffer region, the reduction processing unit 301 of the read image combination unit 215 reads data from the read data buffer region for each block (step S101). Then, the reduction processing unit 301 performs reduction processing on the read data so as to have an output resolution corresponding to the specification of the output data (step S102). The reduction processing unit 301 outputs the pixel data, on which the reduction processing has been performed, in RGB simultaneously, and the gamma correction processing unit 302 performs gamma correction on the outputted data (step S103), and outputs the gamma corrected pixel data to the filter processing unit 303.

When the input of the pixel data from the gamma correction processing unit 302 is received, the data input unit 401 of the filter processing unit 303 writes the data to the internal buffer once and then rearranges the data. When the data of five consecutive pixels in the sub-scanning direction are aligned according to the data written in the buffer and the newly inputted pixel data, the data input unit 401 outputs the pixel data of the internal buffer to the data calculation unit 405 (step S104). At this time, the data input unit 401 outputs a notification signal indicating the output of data to the filter coefficient reading unit 404. When the notification signal is outputted, the computation processing by the data calculation unit 405 is started (step S105).

The filter coefficient reading unit 404 of the filter processing unit 303 reads the filter coefficients k[0] to k[4] from the filter coefficient holding unit 403 based on the initial address register (Addr=0) set in the inclination information holding unit 402, and outputs them to the data calculation unit 405 (step S107). In a case where the processing of step S107 is executed for the first time, the filter coefficients are read based on the initial address register in this manner.

When the filter coefficients are outputted to the data calculation unit 405, the filter coefficient reading unit 404 counts up the address switching counter and the address initialization counter respectively in the filter coefficient reading unit 404. The filter coefficient reading unit 404 compares the count value of the address switching counter with the address switching threshold set in the inclination information holding unit 402. Also, the filter coefficient reading unit 404 compares the count value of the address initialization counter with the address initialization threshold. For example, if the address switching threshold is “1” and the count value of the address switching counter is “1”, it is determined that the address switching condition is satisfied (step S110: Yes), and the subsequent read address (Addr) is switched from “0” to “1” (step S112). At this time, the count value of the address switching counter is initialized. Also, for example, if the count value of the address initialization counter is “1”, it is determined that the condition of the address initialization is not satisfied since the address initialization threshold “11” has not been reached (step S109: No), and the count value of the address initialization counter remains as “1”. In the present embodiment, the comparison with the address initialization threshold (step S109) is performed prior to the comparison with the address switching threshold (step S110).

The data calculation unit 405 of the filter processing unit 303 performs calculation processing using the data inputted from the data input unit 401 and the filter coefficients inputted from the filter coefficient reading unit 404 (step S108). Since the pixel data to be calculated and outputted corresponds to the central pixel coordinates among the coordinates of the five consecutive pixels in the sub-scanning direction, for example, in a case where the pixel data of the coordinates of Di[0,0] to Di[0,4] are inputted, the pixel data of the coordinates [0, 2] is outputted by the data output unit 406. Subsequently, the data of the coordinates of Di[1,0] to [1,4] are inputted from the data input unit 401 to the data calculation unit 405. The filter coefficient reading unit 404 reads the filter coefficients having the address “1” from the filter coefficient holding unit 403 and outputs the filter coefficients to the data calculation unit 405 (step S107 after step S112).

Then, the filter coefficient reading unit 404 counts up the address switching counter and the address initialization counter in the filter coefficient reading unit 404. The filter coefficient reading unit 404 compares the count value of the address switching counter with the address switching threshold set in the inclination information holding unit 402. Also, the filter coefficient reading unit 404 compares the count value of the address initialization counter with the address initialization threshold. For example, if the address switching threshold is “1” and the count value of the address switching counter is “1”, it is determined that the address switching condition is satisfied (step S110: Yes), and the subsequent read address is switched from “1” to “2” (step S112). At this time, the count value of the address switching counter is initialized. Also, for example, if the count value of the address initialization counter is “2”, it is determined that the condition of the address initialization is not satisfied since the address initialization threshold “11” has not been reached (step S109: No), and the count value of the address initialization counter remains as “1”.

Thereafter, the same processing is repeated, and then the data input unit 401 outputs the pixel data of coordinates [10, 0] to [10, 4] to the data calculation unit 405. The filter coefficient reading unit 404 reads the filter coefficients of the address [10] from the filter coefficient holding unit 403 and outputs the filter coefficients to the data calculation unit 405 (step S107). Then, the filter coefficient reading unit 404 counts up the address switching counter and the address initialization counter in the filter coefficient reading unit 404. The filter coefficient reading unit 404 compares the count value of the address switching counter with the address switching threshold set in the inclination information holding unit 402. Also, the filter coefficient reading unit 404 compares the count value of the address initialization counter with the address initialization threshold. At this time, the address switching threshold is “1” and the address initialization threshold is “11”, while the count value of the address switching counter is “1” and the count value of the address initialization counter is “11”. In the present embodiment, in a case where the count value of the address initialization counter is equal to or larger than the address initialization threshold, the address is initialized (step S109: Yes to step S111) in preference to the process of the address switching counter. In such a case, the subsequent read address is initialized from [11] to [0] (step S111). At this time, both the count value of the address switching counter and the count value of the address initialization counter are initialized.

Thereafter, the same processing is repeated in accordance with an increase in coordinates of the pixel data in the main-scanning direction. In a case where the pixel data reaches the end pixel in the main-scanning direction of the block data, for example, when the data of coordinates [m, 0] to [m, 4] are reached, the data input unit 401 subsequently outputs the pixel data of coordinates [0, 1] to [0, 5]. In this case, the filter coefficient reading unit 404 sets the filter coefficient read address (here, address [0]), when the main-scanning coordinate is “0”, as the next reading address, and switches so that the same filter coefficients are applied to the same main-scanning coordinate.

As described above, the filter processing is performed on the pixel data inputted to the filter processing unit 303, and the processed pixel data is written into the filtered image buffer region of the DRAM 203. Similar processing is performed on the read data of each image sensor unit. When the above processing is performed for data read by the image sensor units 105a to 105e, the processing of the filter processing unit 303 ends (step S106: Yes). For the address switching threshold, the address initialization threshold, and the filter coefficients applied in this process, different setting values are used for each image sensor unit (each of image sensor units 105a to 105e).

In the above example, since the address switching threshold is “1”, the address is switched every time the main-scanning coordinates are switched, but in a case where the address switching threshold is a numerical value of 2 or more, the filter coefficient is switched every time the main-scanning coordinates change in units of that numerical value.

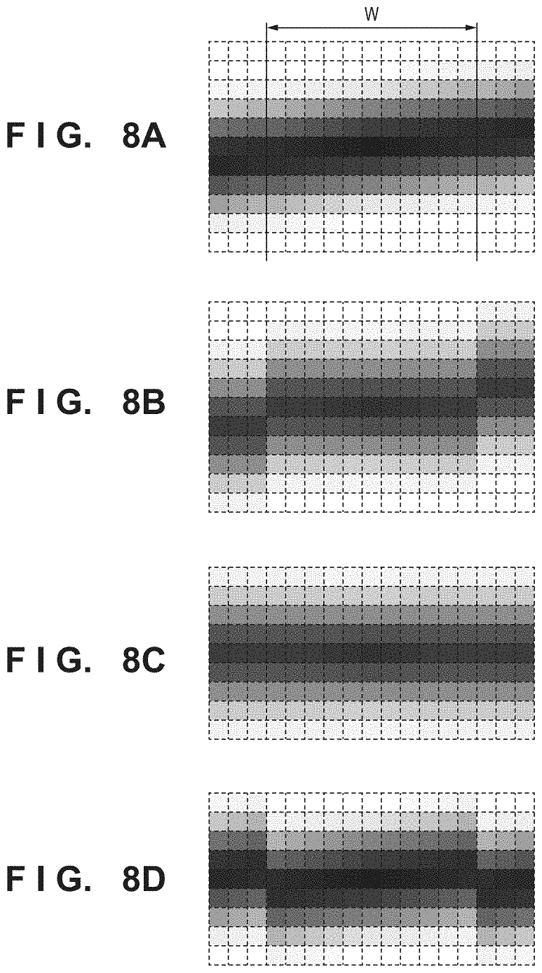

FIGS. 8A to 8D are views illustrating an image read by the image sensor unit 105a and an image after the correction processing. FIG. 8A shows an image obtained when the image sensor unit 105a having an inclination reads an image of a straight line parallel to the main-scanning direction. FIG. 8B illustrates an image after the filter calculation processing when a section W (11 pixels) of FIG. 8A is set as a filter initialization period. As shown in FIG. 8B, in the section W, a gradation conversion, in which an inclination of less than one pixel is corrected, is realized, and furthermore, the spatial frequency in the sub-scanning direction is changed in the image. Meanwhile, the image data adjacent to section W are each shifted by one pixel in the sub-scanning direction in the image. The inclination correction processing unit 304 reads the image data while shifting the read position in the sub-scanning direction according to the filter initialization period for the image data written to the filtered image buffer region of DRAM 203 in the state shown in FIG. 8B.

In FIG. 8C, the image of FIG. 8B is an image on which correction processing has been performed by the inclination correction processing unit 304. As shown in FIG. 8C, by causing the read position in the sub-scanning direction to shift by the filter initialization period and then reading it, an image in which unevenness occurs after the filter processing is corrected to be straight and outputted. FIG. 8D illustrates an image obtained when only the correction processing of the inclination correction processing unit 304 is performed without performing the calculation processing described in the present embodiment in the filter processing unit 303. As shown in FIG. 8D, a rough inclination correction can be performed by shifting in units of one pixel, but it can be seen that the continuity of image at the shift position is lost.

As described above, by configuring the filter processing unit 303 so as to calculate, using the filter coefficients on which weighting processing has been performed, the coefficients for spatial frequency conversion, it is possible to correct an inclination with high accuracy in combination with a pixel position shift circuit. For the filter processing unit 303, by simply applying filter coefficients in accordance with the pixel coordinates in the main-scanning direction, it is possible to maintain connectability with the circuit units before and after the processing is performed in units of blocks. Also, compared to a case where the filter processing for spatial frequency conversion and the weighting processing for inclination correction are performed by separate circuits, the circuit scale can be reduced and the processing time can be speeded up.

In the present embodiment, a configuration has been described in which filter coefficients generated in advance are written in the SRAM and are sequentially read in accordance with the main-scanning coordinates of pixel data. However, the configuration is not limited to such a configuration. For example, configuration may be taken such that a distribution curve for spatial frequency conversion is stored as a lookup table (LUT) so that filter coefficients are outputted for an input of a required shift amount.

In a case where the image sensor units 105a to 105e are configured to have RGB light sources, and are configured to sequentially light up and obtain line data, a phenomenon called color misregistration occurs in color images due to differences in the timing at which the RGB light sources of are emitted. In order to reduce the influence of such a phenomenon, a filter for cutting a high-frequency component in the sub-scanning direction of an image is applied. Configuration may be taken such that the filter coefficients set in the filter processing unit 303 of the present embodiment are set for the purpose of reducing such color misregistration.

Also, in the present embodiment, description has been given for the MFP 100 in which the scanner unit 101 is configured by a plurality of image sensor units 105a to 105e. In such a configuration, a difference in the sharpness of the read images may occur due to a difference in the optical properties or a difference in the mounting positions of the individual image sensor units 105a to 105e. When combination processing between images is executed in such a state, a phenomenon will occur such as a thin line of equal thickness in the original having a partially different thickness in some parts of the processed image. For this reason, it is desirable that the filter coefficients for changing the spatial frequencies to be applied to the respective image sensor units 105a to 105e are set so that the spatial frequencies of the image data after the computation process are substantially the same. When the filter coefficients are set in this manner, the images are combined, and it is possible to suppress the phenomenon such as the thickness of the line differing depending on the area by sharpening processing or the like performed in the read image processing unit 216.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-200393, filed Dec. 9, 2021, which is hereby incorporated by reference herein in its entirety.

What is claimed is:

1. An image forming apparatus, comprising: a reading unit configured to include an image sensor unit in which a reading element for optically reading an original in a main-scanning direction is arranged;
a conversion unit configured to, by performing filter processing of a spatial frequency on read data read by the image sensor unit for each predetermined section of the main-scanning direction, perform gradation conversion of a sub-scanning direction intersecting the main-scanning direction in each predetermined section; and
a correction unit configured to correct read data obtained in accompaniment of an inclination of the image sensor unit by shifting pixels in the sub-scanning direction for data on which the gradation conversion has been performed by the conversion unit, wherein
in the filter processing, a filter coefficient for which a weighting has been set is used for each of a plurality of pixels in the sub-scanning direction in the predetermined sections, and
the weighting for each of the plurality of pixels is determined such that the center of gravity of the weighting shifts in the main-scanning direction gradually from one end of the predetermined section to the other end.

2. The image forming apparatus according to claim 1, wherein filtering strength in units of the plurality of pixels is constant in the main-scanning direction.

3. The image forming apparatus according to claim 1, wherein in a case where another end of a first predetermined section as the predetermined section is adjacent to one end of a second predetermined section as the predetermined section, the center of gravity of the weighting at one end of the first predetermined section corresponds to the center of gravity of the weighting at one end of the second predetermined section, and the center of gravity of the weighting at the other end of the first predetermined section corresponds to the center of gravity of the weighting at the other end of the second predetermined section.

4. The image forming apparatus according to claim 3, wherein a shift in the sub-scanning direction between a result of the filter processing at the other end of the first predetermined section and a result of the filter processing at one end of the second predetermined section corresponds to a shift amount in the correction unit.

5. The image forming apparatus according to claim 1, wherein the weighting of the filter coefficients corresponding to each of the plurality of pixels is set based on a normal distribution curve.

6. The image forming apparatus according to claim 1, wherein convolution of the plurality of pixels in the sub-scanning direction is performed in the filter processing.

7. The image forming apparatus according to claim 1, further comprising: a storage unit configured to store the filter coefficients, wherein
the conversion unit reads from the storage unit the filter coefficients corresponding to an address of the main-scanning direction in the predetermined section and performs the filter processing.

8. The image forming apparatus according to claim 1, wherein the reading unit has a plurality of the image sensor units, and
the gradation conversion by the conversion unit and the correction by the correction unit are performed on read data read by each of the plurality of the image sensor units.

9. The image forming apparatus according to claim 8, further comprising: a combination unit configured to combine data on which correction by the correction unit has been performed together for each of the plurality of the image sensor units.

10. The image forming apparatus according to claim 9, further comprising: an image processing unit configured to execute image processing on the data combined by the combination unit.

11. The image forming apparatus according to claim 10, wherein the image processing includes edge emphasis processing.

12. The image forming apparatus according to claim 10, further comprising: a printing unit configured to execute printing on a printing medium based on the data on which the image processing has been executed by the image processing unit.

13. The image forming apparatus according to claim 8, wherein the plurality of image sensor units are arranged staggered.

14. A method for controlling an image forming apparatus, the method comprising:
by performing filter processing of a spatial frequency on read data read by the image sensor unit, in which a reading element for optically reading an original in a main-scanning direction is arranged, for each predetermined section of the main-scanning direction, performing gradation conversion of a sub-scanning direction intersecting the main-scanning direction in each predetermined section,
correcting read data obtained in accompaniment of an inclination of the image sensor unit by shifting pixels in the sub-scanning direction for data on which the gradation conversion has been performed, wherein
in the filter processing, a filter coefficient for which a weighting has been set is used for each of a plurality of pixels in the sub-scanning direction in the predetermined sections, and
the weighting for each of the plurality of pixels is determined such that the center of gravity of the weighting shifts in the main-scanning direction gradually from one end of the predetermined section to the other end.
